(19) United States
(12) Patent Application Publication
(10) Pub. No.: US 2014/0356537 A1
(43) Pub. Date: Dec. 4, 2014

(54) METHOD FOR CREATING A SCRATCH-OFF DOCUMENT USING SINTERING

(71) Applicants: Dinesh Tyagi, Fairport, NY (US); Louise Granica, Victor, NY (US)

(72) Inventors: Dinesh Tyagi, Fairport, NY (US); Louise Granica, Victor, NY (US)

(21) Appl. No.: 13/906,389

(22) Filed: May 31, 2013

(51) Int. Cl. B05D 7/00

(52) U.S. Cl. CPC B05D 7/54
USPC 427/258

(57) ABSTRACT

A method for creating a scratch-off document, the method includes the steps of providing a substrate with an image; covering the image with a scratch-off toner; sintering the scratch-off toner; wherein an amount of the sintering of the scratch-off toner is determined from a group consisting of pressure, speed, and mass of the scratch-off toner so that the scratch-off toner is sintered at a level which permits removal.

### CROSS-REFERENCE TO RELATED APPLICATION

Reference is made to commonly-assigned U.S. patent application Ser. No. ______ filed concurrently herewith, entitled “Method For Creating A Scratch-Off Document With Low Energy Components” by Dinesh Tyagi et al, the disclosure of which is incorporated herein.

### FIELD OF THE INVENTION

The present invention generally relates to scratch-off documents having an image covered by a scratch-off layer and more particularly to sintering the scratch-off layer that is easily removed during scratch-off.

### BACKGROUND OF THE INVENTION

Currently, scratch-off documents are used for a variety of applications. One of the most commonly used applications is the use of scratch-off documents for creating lottery tickets. In this application, a person purchases a lottery ticket and uses a hard object to scratch off the portion of the ticket covering hidden information such as a particular number. The use of scratch-off documents has vastly increased over the past years and several prior art documents address creating scratch-off documents.

In this regard, U.S. Patent Application Publication 2007/0281224 is directed to a scratch-off document in which a first layer of toner forms an image which is first fixed to the substrate. An optional barrier layer, typically clear, is deposited and then affixed hereon. The first layer is well adhered to the substrate and the barrier layer is well adhered to the first layer. A second removable layer of toner is imaged and adhered to the first layer or the barrier layer in a second fixing step. The second toner layer is incompatible with the first toner layer and the barrier layer and can be removed when scratched using a hard object, leaving the first layer intact on the substrate. The application of the barrier layer is carried out offline and the document is reprinted with the scratch-off layer.

U.S. Patent Application Publication 2008/0131176 is directed to an apparatus and method for producing a scratch-off document in which front side information containing the information to be hidden prior to scratch-off is first fused or otherwise well adhered to the base material prior to the printing of a removable scratch-off layer.

U.S. Patent Application Publication 2009/0263583 is directed to a scratch-off document in which the information layer includes both an indicia and a noise component of varying height. A scratch off layer is deposited over the noise component. This variable height functions to obscure the indicia so that it is not easily seen until scratched off.

U.S. Pat. No. 8,342,576 is directed to a scratch-off document having a first toner layer containing hidden information (i.e., the image that will eventually be revealed to the user after scratch off). The first layer is fixed to the substrate and then covered by a printed, removable, waxy scratch-off layer having a distraction pattern.

Although each is satisfactory, cost efficiency improvements are always needed, as is the need for simple, but efficient scratch-off documents.

### SUMMARY OF THE INVENTION

A method for creating a scratch-off document, the method comprising the steps of: providing a substrate with an image; covering the image with a scratch-off toner; sintering the scratch-off toner; wherein an amount of the sintering of the scratch-off toner is determined from a group consisting of pressure, speed, and mass of the scratch-off toner so that the scratch-off toner is sintered at a level which permits its removal.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, and wherein:

FIG. 1 is a block diagram of an electro-photographic reproduction apparatus suitable for use in the practice of the present invention;

FIG. 2 is a side view in cross section illustrating a substrate having underlying toner deposited thereon according to one embodiment of the present invention;

FIG. 3 is a side view of FIG. 2 after the underlying toner is fixed to the substrate forming a fixed image layer;

FIG. 4 is a side view illustrating scratch-off toner deposited onto the underlying fixed image layer;

FIG. 5 is a side view of FIG. 4 after the scratch-off toner is sintered forming a fixed scratch-off layer;

FIG. 6 is a side view after the scratch-off layer is removed by the scratch-off tool revealing the hidden information;

FIG. 7 is a top view of FIG. 6 along line 6-6 with the scratch off tool removed from view for illustrating the hidden information, the letter “K” in this example; and

FIG. 8 is an alternative embodiment of FIG. 2 having an indicia image printed on the substrate before depositing the scratch-off toner and an optional non-image toner.

### DETAILED DESCRIPTION OF THE INVENTION

Before turning to the description of the present invention, it is important to note terms as used herein. In this regard, “sintering” means to form a continuous or substantially continuous mass without melting or without substantially melting. In sintering, the toner particles coalesce into a continuous mass through the application of pressure resulting in cold flow and cohesion of the particles. When a toner image is “fixed” to a substrate by fusing, sufficient heat is provided to cause a melt flow of the toner melt to penetrate into the substrate structure or to simply provide mechanical interlocking with the substrate. Thus the final image is well adhered to the substrate and cannot be removed easily. The resulting well adhered images do not lend themselves to provide a suitable scratch off document. However, by using the “sintering” process, the toner mass can be made to flow at ambient or very low temperatures. This can be achieved by making the toner particles to undergo cold flow. Cold flow can be described as the distortion, deformation, or dimensional change which takes place in materials under load at temperatures within the working range. In other words, cold flow is described as flow of thermoplastic materials that occurs at less than the optimum melt temperatures. Cold flow can also be described in terms of plastic flow under severe friction conditions. Therefore, cold flow is not due to heat softening or a melt process in which the materials has to undergo a phase transition. It is sometimes described as creep or compression set of the polymer that occurs at ambient temperature and is related to the viscoelastic flow of polymers under applied pressure.

It is understood by those skilled in the art that partial melting can occur as a result of imprecision of the devices used or melted intentionally to a partial degree that still achieves the result of permitting scratch-off.

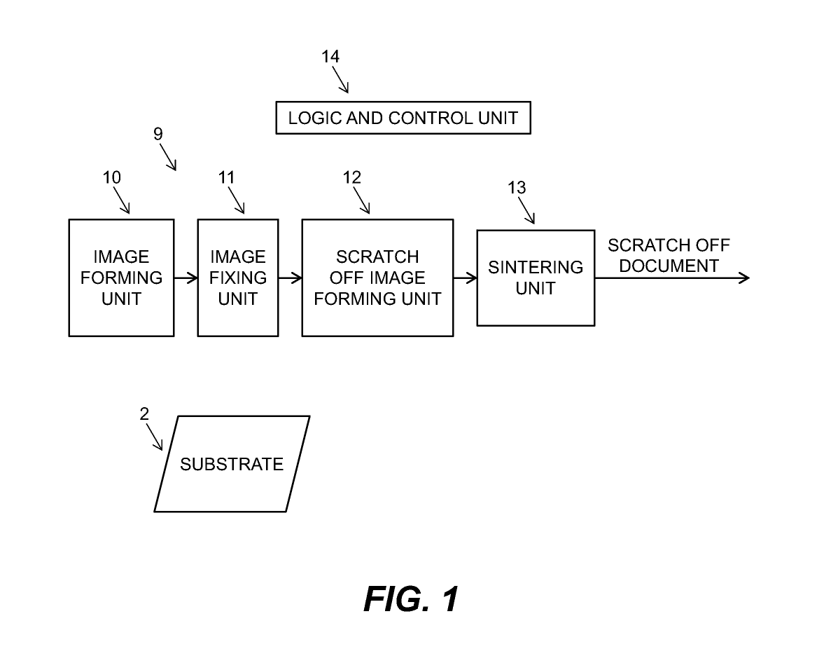

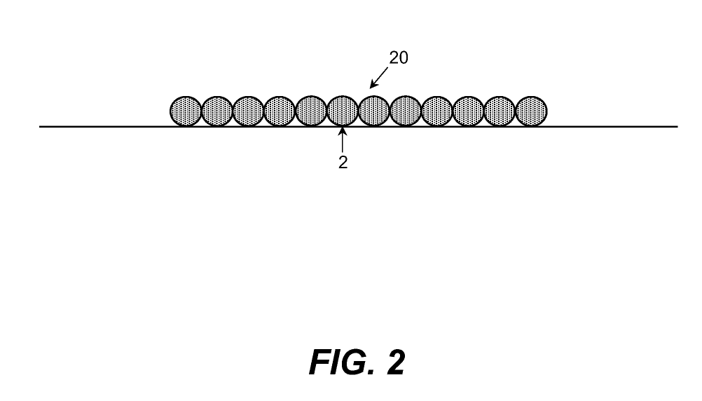

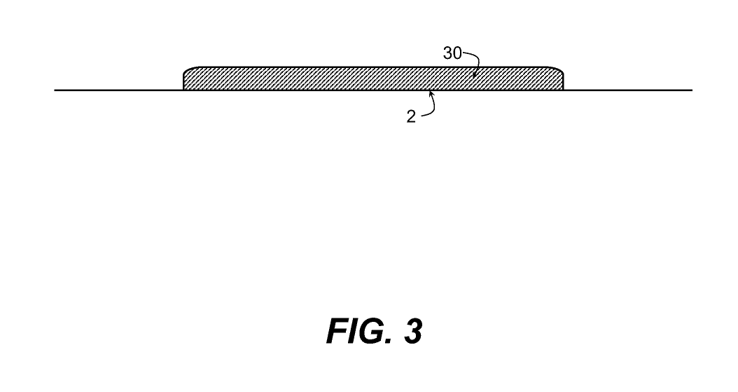

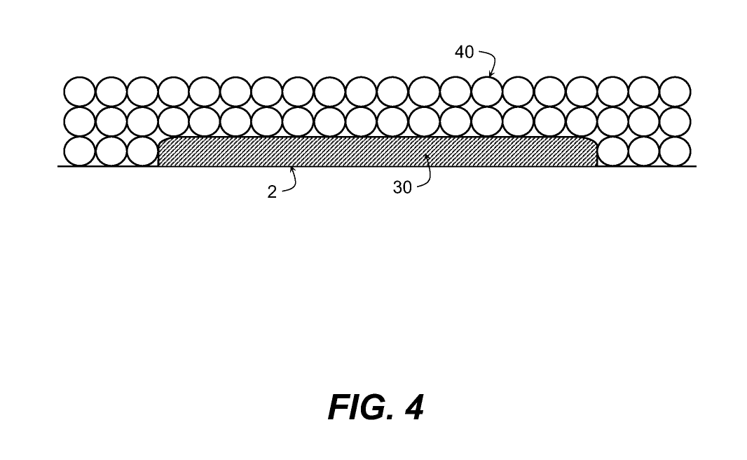

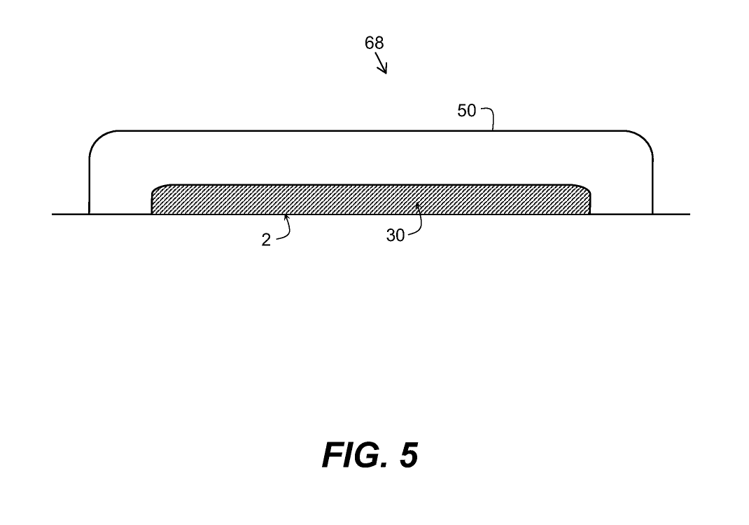

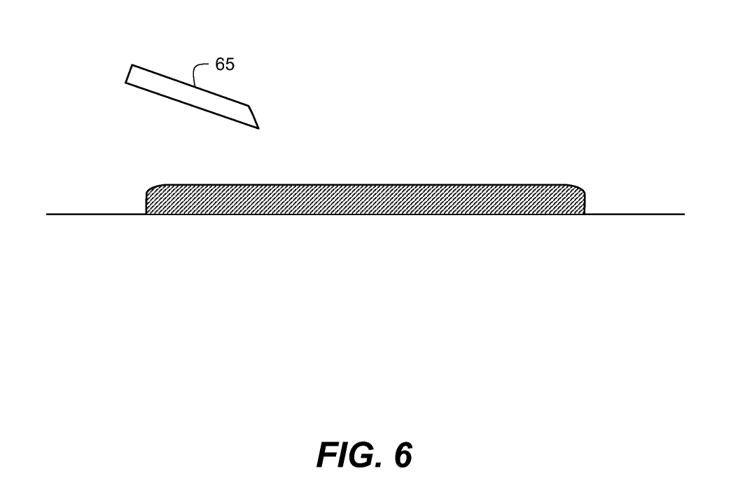

Referring to FIG. 1, there is shown a block diagram of a scratch-off document apparatus 9. The scratch-off document apparatus 9 includes an image forming unit 10 into which a substrate 2 is input. The image forming unit 10 deposits an underlying toner 20 (as shown in FIG. 2) onto the substrate 2, as is well known in the art, and passes the substrate 2 to an image fixing unit 11. The image fixing unit 11 functions to adhere the underlying toner 20 to the substrate 2 which transforms the underlying toner 20 into a fixed image layer 30 (as shown in FIG. 3) on the substrate 2. The fixed image layer 30 is well adhered to the substrate 2 by any suitable mechanism such as two nip forming heated rollers, vapor fusing, flash fusing, infrared radiation fusing, or microwave, all of which are well known in the art. The substrate 2 with the fixed image layer 30 is passed to a scratch-off image forming unit 12, which deposits a scratch-off toner 40 (as shown in FIG. 4) onto the fixed image layer 30 and also onto the substrate 2 not covered by the fixed image layer 30. A sintering unit 13 receives the substrate 2 with the fixed image layer 30 and scratch-off toner 40 from the scratch-off image forming unit 12 and sinters the scratch-off toner 40. This sintering transforms the scratch-off toner 40 into a sintered scratch-off layer 50 (as shown in FIG. 5). This produces a scratch-off document 68 (see FIG. 5) in which the sintered scratch-off layer 50 is mechanically removed (as shown in FIG. 6). A logic and control unit 14 controls the scratch-off document apparatus 9 and in particular it controls the pressure, speed, and temperature of the scratch-off document apparatus 9 and mass of the scratch-off toner 40.

Referring to FIG. 2, there is shown a side view of the substrate 2 having the underlying toner 20 applied thereon by the image forming unit 10. The substrate 2 is preferably, but not limited to, paper or any suitable printing media receptive to toner printing. It is noted that the underlying toner 20 is patterned in a predetermined shape on the substrate 2. This predetermined shape is representative of, but not limited to, symbols, numbers, letters and other symbols used in writing, art and the like. Referring to FIGS. 2 and 3, the substrate 2 with the underlying toner layer 20 is passed through the image fixing unit 11 so that the underlying toner 20 is fixed to the substrate 2 which results in the fixed image layer 30. It is understood by those skilled in the art that the underlying toner 20 can be fused to the substrate 2 by the image fixing unit 11.

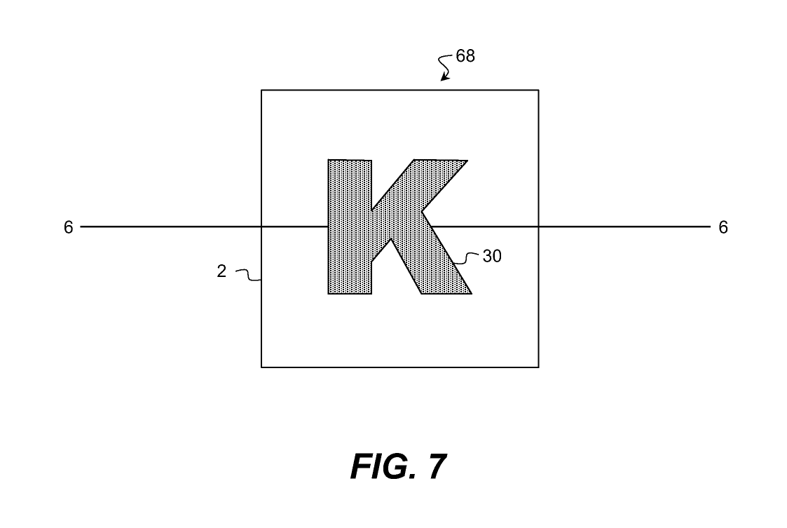

Referring to FIG. 4, a scratch-off toner 40 of opaque composition is applied by the scratch-off image forming unit 12, and the scratch-off toner 40 covers and abuts the fixed image layer 30. The scratch-off toner 40 also extends beyond the fixed image layer 30 so that it abuts the substrate 2 in areas not covered by the fixed image layer 30. The scratch-off toner 40 functions to ensure that the predetermined shaped formed by the fixed image layer 30 (hidden information) is obscured from view until it is scratched off. The substrate 2 having the scratch-off toner 40 and fixed image layer 30 is then passed through the sintering unit 13 for sintering the scratch-off toner 40 onto the fixed image layer 30 and the substrate 2. Referring to FIG. 5, the sintering causes the scratch-off toner 40 to become a sintered scratch-off layer 50. The combination of the substrate 2, the fixed image layer 30 and the sintered scratch-off layer 50 forms the scratch-off document 68 (see FIGS. 5 and 7).

Referring to FIG. 5, it is noted that the fixed toner layer 30 is fixed to the substrate 2 at a sufficient level which permits the fixed toner layer 30 to stay intact during scratch-off of the sintered scratch-off layer 50. However, the sintered scratch-off layer 50 is sintered onto the substrate 2 and the fixed image layer 30 at a level which permits scratch-off. The amount of the sintering of the scratch-off toner 40 is determined from a group consisting of pressure, speed, and mass of the scratch-off toner. It is understood that the logic and control unit 14 controls the pressure, speed and mass of the scratch-off toner 40 that is applied by the scratch-off document apparatus 9 to achieve the desired sintering, as understood by those skilled in the art. The pressure, speed, and mass of the scratch-off toner 40 can be applied individually or in any combination to achieve the desired level of sintering. It can also be advantageous to raise the temperature during the sintering process to help with the sintering but care must be taken to ensure that increased temperature should not cause a heat softening or a melt process in which the materials undergoes a phase transition.

The scratch-off toner 40 preferably has properties that permit it to scratch-off optimally. In this regard, the scratch-off toner 40 includes particles at least 10 microns larger than the underlying image toner 20. The scratch-off toner 40 also has a molecular weight of between 2,000 and 100,000 and a glass transition temperature, Tg, between 50 degrees Celsius and 80 degrees Celsius.

The scratch-off toner 40 can also be heated up to a temperature less than 10 degrees below the glass transition temperature during sintering. In another embodiment, the scratch-off toner 40 further includes a semi-crystalline additive, which has a melt temperature, Tm, of between 60 degrees Celsius and 120 degrees Celsius. Amount of the optional semi-crystalline additive can range from 10 to 60% by weight of the total scratch-off toner composition. The degree of the semi-crystalline additive can range from 60 to 90% by weight of the total weight of semi-crystalline additive. The scratch-off toner 40 can also be heated up to a temperature less than 10 degrees below the melt temperature during sintering. Lastly, the mass of the scratch-off toner 40 is preferably greater than 0.7 mg/cm².

Referring to FIG. 6, there is shown a scratch-off tool 65, such as a hard rigid object, fingernail or any object suitable for scratching off the sintered scratch-off layer 50. The sintered scratch-off layer 50 is removed thereby revealing the hidden information formed by the fixed image layer 30. Referring to FIG. 7, there is shown the letter “K” formed by fixed image layer 30, as an example.

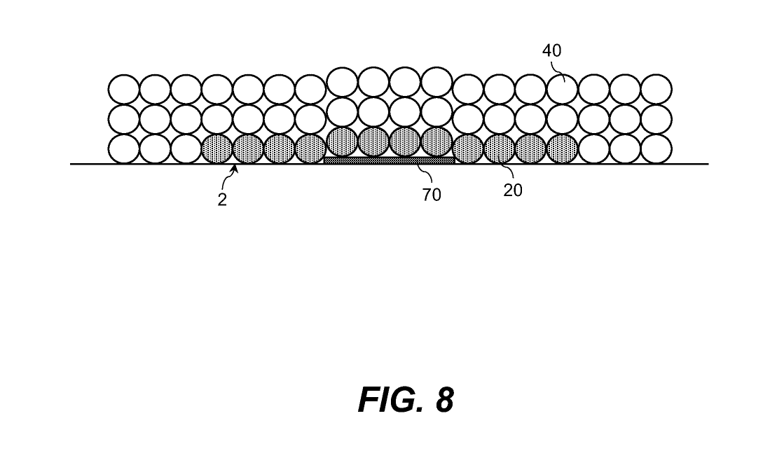

Referring to FIG. 8, there is shown an alternative embodiment of the present invention. In this embodiment, the predetermined shaped or image, indicia 70, is pre-printed on the substrate 2 and consists of any suitable printing output such as ink, dyes, toner or the like. The devices used for depositing the indicia 70 on the substrate 2 are well known in the art. Thereafter, the substrate 2 is put into the scratch-off image forming unit 12 and the underlying toner 20 is deposited and sintered. In this embodiment, this sintered underlying toner 20 is scratched off to reveal the indicia 70. Alternatively, the scratch-off toner 40 can be deposited on the underlying toner 20 for providing an additional layer for hiding the indicia 70. For the purpose of hiding the indicia 70, it would be advantageous for the underlying toner 20 to be opaque and nearly the same color as the indicia 70. The underlying toner 20 could be formed using one or more color toners and imaged over the informational area to be hidden until mechanically removed. Since the underlying toner 20 does not form the image as in the previous embodiment, for purposes of term differentiation, the underlying toner 20 is referred to as the non-image toner 20 in this embodiment. After sintering, the non-image toner 20 forms a sintered non-image layer 30 (as opposed to a fixed image layer 30 as in the previous embodiment) which would be similar to FIG. 5 except that the indicia 70 lies between the substrate 2 and the sintered scratch-off layer 50. The combination of the substrate 2, the sintered non-image layer 30 and the sintered scratch-off layer 50 forms the scratch-off document 68 in this embodiment. In this embodiment, the both sintered non-image layer 30 and sintered scratch-off layer 50 would be scratched off. It is noted that any height difference due to the indicia 70 is imperceptible to the touch so that the outline of the indicia 70 is not revealed.

The present invention has been described in detail with particular reference to certain preferred embodiments thereof, but it will be understood that variations and modifications can be effected within the spirit and scope of the invention.

### PARTS LIST

2 substrate

9 scratch-off document apparatus

10 image forming unit

11 image fixing unit

12 scratch-off image forming unit

13 sintering unit

14 logic and control unit

20 underlying toner or non-image toner

30 fixed image layer or sintered non-image layer

40 scratch-off toner

50 sintered scratch-off layer

65 scratch-off tool

68 scratch-off document

70 indicia

1. A method for creating a scratch-off document, the method comprising:
providing a substrate with an image;
covering the image with a scratch-off toner;
sintering the scratch-off toner;
wherein an amount of the sintering of the scratch-off toner is determined from a group consisting of pressure, speed, and mass of the scratch-off toner so that the scratch-off toner is sintered at a level which permits removal.

2. The method as in claim 1, wherein the mass of the scratch-off toner is greater than 0.7 mg/cm².

3. The method as in claim 1, wherein the step of providing a substrate with the image includes applying an underlying toner between the substrate and the scratch-off toner; wherein the underlying toner includes the image.

4. The method as in claim 3, wherein the underlying toner is fixed before applying the scratch-off toner resulting in a fixed toner layer.

5. The method as in claim 1, wherein the step of providing a substrate with the image includes applying a non-image toner between the substrate and the scratch-off toner; wherein the image is preprinted before applying the non-image toner.

6. The method as in claim 5, wherein the non-image toner is sintered before or while applying the scratch-off toner.

7. The method as in claim 3, wherein the scratch-off toner includes particles at least 10 microns larger than image toner.

8. The method as in claim 5, wherein the scratch-off toner includes particles at least 10 microns larger than non-image toner.

9. The method as in claim 1, wherein the scratch-off toner has a molecular weight of between 2,000 and 100,000.

10. The method as in claim 1, wherein the scratch-off toner has a glass transition temperature, Tg, between 50 degrees Celsius and 80 degrees Celsius.

11. The method as in claim 1, wherein the scratch-off toner is heated to a temperature less than 10 degrees below the glass transition temperature.

12. The method as in claim 1, wherein the scratch-off toner includes a semi-crystalline additive.

13. The method as in claim 11, wherein the semi-crystalline additive has a melt temperature, Tm, of between 60 degrees Celsius and 120 degrees Celsius.

14. The method as in claim 11 wherein the semi-crystalline additive is present in the amount between 10 and 60% by weight of total scratch-off toner weight.

15. The method as in claim 11 wherein the crystallinity of the semi-crystalline additive ranges between 50 and 90% if its weight.

16. The method as in claim 1, wherein the scratch-off toner is heated to a temperature less than 10 degrees below the melt temperature.

17. The method as in claim 1, wherein the scratch-off toner is opaque.
